(19) United States
(12) Patent Application Publication
(10) Pub. No.: US 2009/0024356 A1
(43) Pub. Date: Jan. 22, 2009

(54) DETERMINATION OF ROOT CAUSE(S) OF SYMPTOMS USING STOCHASTIC GRADIENT DESCENT

(75) Inventors: John C. Platt, Bellevue, WA (US); Erme Mehment Kiciman, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/778,421

(22) Filed: Jul. 16, 2007

(51) Int. Cl. G06F 17/18; G06F 15/00

(52) U.S. Cl. 702/181; 702/185

(57) ABSTRACT

Diagnosis of one or more root causes of symptoms is performed by using stochastic gradient descent to find the optimal parameters of a variational distribution. This methodology, called variational gradient descent, permits fast diagnosis for a large number (greater than 1,000) or very large number (greater than 1,000,000) of symptom observations. A real-time application of the root cause diagnosis can determine currently occurring intermittent root causes. Diagnosis can be performed in a number of scenarios, such as medical disease detection or computer/network failure.

### BACKGROUND

Diagnosis of a root cause of symptoms is a common problem faced by professionals and technicians. For example, a doctor determines what disease a patient has based on a patient's symptoms. An auto mechanic determines the root cause of car problems based on the car's symptoms. A computer technician determines the root cause of computer faults. However, the determination of a root cause is complex since a single symptom can have multiple root causes and a single root cause can have multiple symptoms. Furthermore, all symptoms of a root cause need not be present every time the root cause is present and one or more symptoms can be present when nothing is wrong. However, until the professional or technician can diagnosis the root cause, the professional or technician can only treat the symptoms (if possible) and not correct or treat the root cause.

The professional or technician needs assistance in determining the root cause as the number of possible root causes and symptoms increase. Thus, a number of computer-implements methods exist to determine the root cause of symptoms. For example, QuickScore and Monte Carlo methods have been used. However, these methods are very slow as the number of symptoms increase. In addition, these methods are unable to analyze symptoms as the symptoms are observed/detected and report a current guess of the root cause.

The above-described deficiencies of current root cause determination methods are merely intended to provide an overview of some of the problems of today's root cause determination techniques, and are not intended to be exhaustive. Other problems with the state of the art may become further apparent upon review of the description of various non-limiting embodiments of the invention that follows.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

Diagnosis of one or more root causes of symptoms is performed by using stochastic gradient descent to find the optimal parameters of a variational distribution. This methodology, called variational gradient descent, permits diagnosis for a large number of symptom observations (e.g., greater than 1000 symptom observations, including a very large number of symptom observations such as 1,000,000 symptom observations). A block version of variational inference and mean field approximation is utilized to approximate the probability disease vector given a vector of observed symptoms. Then, stochastic gradient descent is then used to solve the optimization problem that arises from variational inference.

A real-time version or near real-time version of variational gradient descent can be utilized to determine rates of the root causes in real-time, such as for time-varying root causes. Time-varying root causes intermittently appear and do not last until treated. The symptom observations can determine faults and the rate of faults over time. Thus, problems with a patient or a system, such as faults in a computer network or operating system, can be tracked while further symptom observations are still being made. Historical analysis can also be performed using variational gradient descent on a very large number of symptoms.

Secondary processing of the identified root causes can be performed to determine if and how a user technician is notified about the root cause. For example, various root causes can be prioritized according to their severity, such as the number of customers of the diagnosed system affected. Furthermore, treatment of the root cause can be automatically performed after diagnosis.

The following description and the annexed drawings set forth in detail certain illustrative aspects of the claimed subject matter. These aspects are indicative, however, of but a few of the various ways in which the principles of the claimed subject matter can be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 is a schematic diagram of an exemplary environment for the root cause determination architecture according to one embodiment.

FIG. 2 is a block diagram that illustrates various exemplary components of the root cause determination system according to one embodiment.

FIG. 3 illustrates the subcomponents of the root cause determination component according to one embodiment.

FIG. 4 depicts a prioritization component according to one embodiment.

FIG. 5 depicts an exemplary flow chart of historical root cause determination according to one embodiment.

FIGS. 6A-6B depict an exemplary scenario in which root cause determination is performed.

FIGS. 7A-7C depict an exemplary user interface for indicating the diagnosed root causes according to the illustrated scenario.

FIG. 8 illustrates a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used herein, “symptom” refers to both positive indications of a problem (“positive symptoms”) and negative indications of a problem (e.g., normal conditions). “Symptom observation” refers to the presence of a symptom at a given time and is a symptom observation regardless of whether the symptom was observed, detected, or inferred. A symptom can be inferred when direct observation or direct detection is impractical or costly and an indirect observation indicates a symptom is present.

“Disease” refers to any abnormal condition with one or more symptoms, regardless of whether the abnormal condition occurs in a living thing, machine, or system. In the case of computer-implemented systems and networks, a “disease” can include intermittent faults with the one or more computer components, whether in software or hardware. A “root cause” is a disease or alternatively in some embodiments the cause of a disease. For example, in an automobile, a number of symptoms can be caused by a failed computer—an exemplary disease—however, the underlying root cause of the disease can nonetheless be an electrical component shorting the computer and causing it to fail. As a second example, AIDS is a medical disease whose root cause is an HIV infection.

For the sake of clarity, the diagnosis of a computer network (e.g., the Internet or a corporate intranet) is illustrated and described as an exemplary non-limiting embodiment. However, one will appreciate that the root cause determination can be performed in various other scenarios. For example, the diagnosis can be used to diagnose root causes or diseases in animal, plant or human patients, computer operating systems, distributed computing systems, telephone networks, and sophisticated machines (e.g., motor vehicles, copiers).

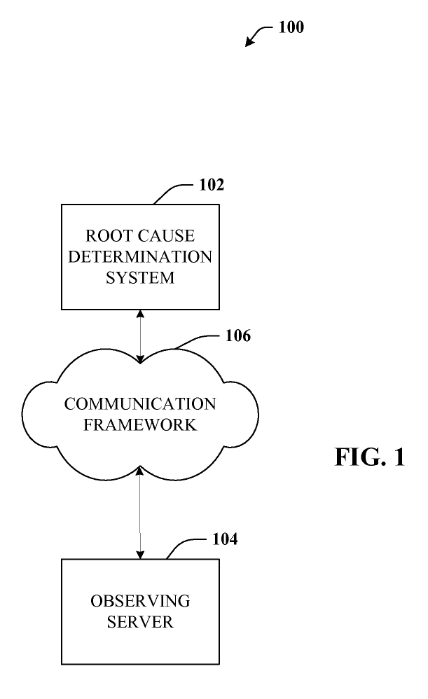

Referring now to FIG. 1, there is illustrated a schematic block diagram of an exemplary computing environment operable to execute root cause determination architecture. For the sake of simplicity, only a single system/server of each type is illustrated, but one skilled in the art will appreciate that there can be multiple systems/servers of a given type and that some of the types can have their functionality distributed between various computers. Furthermore, one will appreciate that a single machine can also host some or all of the processes of the other machine types.

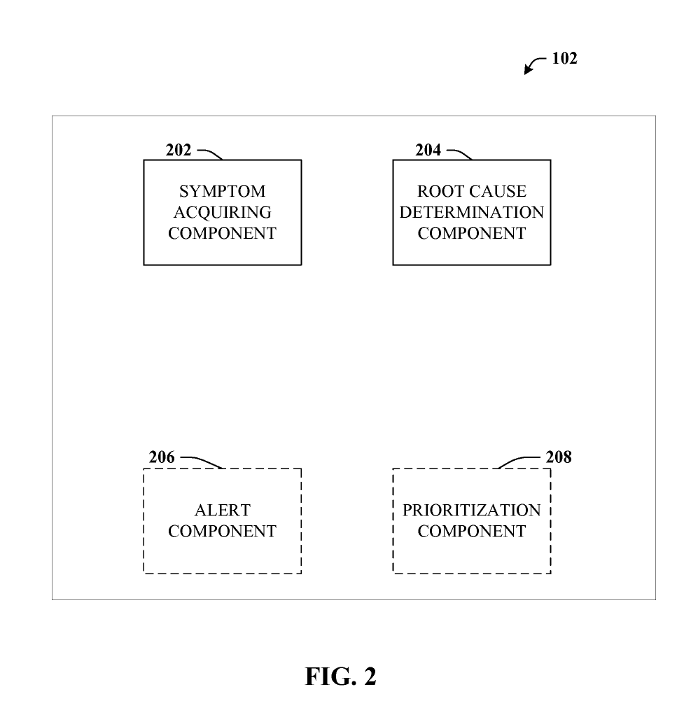

The environment 100 includes a root cause determination system 102. The root cause determination system 102 can be hardware and/or software (e.g., threads, processes, computing devices). The root cause determination system is described in further detailed with regard to FIG. 2.

The environment 100 also includes one or more observing servers 104. The observing servers 104 can also be hardware and/or software (e.g., threads, processes, computing devices). The observing servers 104 can house threads to detect, observe, or infer a current symptom. The observing server can also perform other functionality. For example, in one exemplary embodiment, the observing server is a web server that also observes symptoms although the observing server can offer other services (e.g. FTP, mail, database access, etc.). In other embodiments, the observing server can be a stand-alone server that other servers (not shown) use to log symptoms.

One possible communication between an attendee client 102 and observing servers 104 can be in the form of data packets adapted to be transmitted between two or more computer processes. The data packets can include one or more observed symptoms. For example, the observing servers 104 can transmit the observed symptoms in substantially real-time for substantially real-time analysis. In other embodiments, some or all of the symptoms can be transmitted in blocks asynchronously, such as symptoms recorded in or inferred from log files for near real-time (e.g., delayed by 5 minutes to 24 hours) or historical analysis.

The environment 100 includes a communication framework 106 (e.g., a global communication network such as the Internet; a corporate intranet or the public switched telephone network) that can be employed to facilitate communications between the root cause determination system 102 and the observing servers 104. Communications can be facilitated via a wired (including optical fiber) and/or wireless technology and via a packet-switched or circuit-switched network.

Referring to FIG. 2, exemplary components of the root cause determination system 102 are illustrated. For the sake of clarity, only a single component of each type is illustrated within a single system; however, one will appreciate that there can be multiple components of each type in at least some root cause determination systems 102 and that the components can be distributed between different machines, threads or processes.

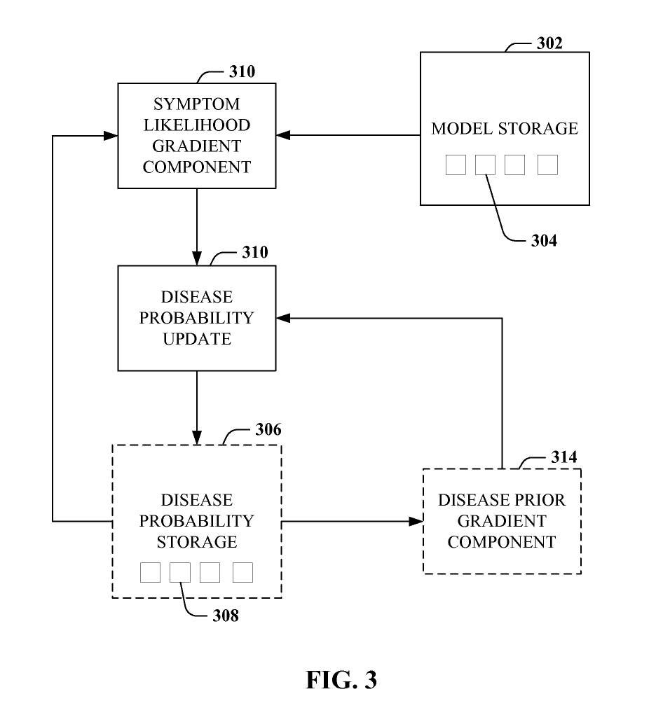

The illustrated root cause determination system comprises a symptom acquiring component 202, a root cause determination component 204, and optionally an alert component 206 and a prioritization component 208. The symptom acquiring component 202 receives indications of multiple symptom observations. As previously stated, these symptom observations can be received in a block manner or one at a time (e.g., in real-time processing). The symptoms are observed, detected, inferred, manually entered, or any combination thereof. Depending on the nature (e.g. real-time vs. offline) of the root cause determination by the root cause determination component, the symptom observations can be stored temporarily, such as in a database (not shown). The root cause determination component 204 determines one or more root causes using variational gradient descent. Further details about variational gradient descent and the root cause determination component are discussed with respect to FIG. 3.

The alert component 206 indicates one or more of the determined root causes to a technician user. As part of the indication, the alert component can also format the presentation of some or all of the indications for the device the indication will displayed on (e.g., smart phone vs. computer monitor). The alert component can also be configured to aggregate some or all root cause with a predefined period of time, such as 10 minutes.

The prioritization component 208 determines how to indicate at least one of the determined one or more root causes to a technician user. In one embodiment, predetermined rules are used to determine whether and how to indicate the root causes. The predetermined rules can prevent false alarms. For example, the alert component can be user-configured to indicate a root cause when a probability of the root cause exceeds a certain probability (e.g. 0.5) or when the number of symptom observations resulting in the probability exceeds a threshold number. In addition, the prioritization component can also determine the severity of the root cause, such as the number of users of the diagnosed system that are unable to reliably use it. As the severity increases, it is more likely to interact with the alert component to send an alert immediately.

The prioritization component 208 also determines the manner of the indication, such as via email, phone call, instant message, text/video messaging and can determine the formatting. For example, the prioritization component can determine and instruct the alert component to display a graph of real-time faults for a particular computer device.

FIG. 3 illustrates the subcomponents of the root cause determination component 204. In this illustrated non-limiting example, the root cause determination component comprises model storage 302 containing a plurality of models 304, disease probability storage 306 containing a plurality of disease probability parameters 308, a symptom likelihood gradient component 310, and a disease probability updater 312. Optionally, the root cause determination component can also comprise a disease prior gradient component 314.

Model storage 302 contains a plurality of models 304. Each model 304 describes how a symptom can arise from a subset of the diseases. This subset can consist of one disease, a plurality of diseases, or all of the diseases. The model 304 is established before root cause determination, including any parameters in the model which are fixed. One exemplary instance of a model 304 is a noisy-OR model. A noisy-OR model describes a probability of observing a negative symptom indexed by j given the probability of seeing each of its possible root causes indexed by i:

$$Log ( P ( {s}_{j} = false \vert D ) ) = log ( 1 - {r}_{j 0} ) + {\sum }_{i} log ( 1 - {r}_{j i} {q}_{i} )$$

where qᵢ is the current estimate of the probability of disease i, rⱼ₀ is the probability that symptom j is positive spontaneously (for no known cause), and rⱼᵢ is the probability that symptom j is positive for disease i. This estimate can describe the uncertainty of seeing a disease that is either present or absent, or can describe the estimate of rate of an underlying root cause that is intermittently present.

Disease probability storage 306 contains a plurality of disease probability parameters 308. Each disease probability parameter comprises one or more parameters that describe the current estimate of the probability of the disease. The disease probability estimate can take on several forms, each of which may have a different set of parameters 308. For example, if the disease is either present or absent, then the disease probability estimate can be parameterized by one number zᵢ for each disease, which represents the system's belief that disease i is present. This zᵢ is the log odds of the system's belief, which is a number that can range from negative infinity to infinity. It can be converted back into a probability by using the link function:

$${q}_{i} = \frac{1}{1 + exp ( {z}_{i} )}$$

where exp(n), returns e, the base of natural logarithms, raised to the n power. The reason for not explicitly storing a probability is that it permits disease probability updater 312 to update zᵢ without constraints: all values of zᵢ map into valid probability distributions, while only the interval [0,1] are valid probabilities.

If the disease is an intermittent disease, it is present with a mean rate qᵢ. In this case, when a symptom observation is made, the underlying disease is present or absent with some probability qᵢ, the disease being redrawn every time a symptom observation is made. This probability can be stored as log odds zᵢ, and the probability recreated using the link function, above.

Alternatively, the parameters 308 can represent the uncertainty that the system has in the underlying disease. For example, a parameter 308 can consist of two numbers, a and b, which parameterize a Beta distribution that encapsulates the system's uncertainty about the rate of an intermittent disease. In this case, the α parameter of a Beta distribution would be computed from exp(a), and the beta parameter would be computed from exp(b).

Symptom likelihood gradient component 310 serves to compute the gradient of the log likelihood of a symptom observation with respect to one or more disease probability parameter 308. The computation within the symptom likelihood gradient component 310 depends on the form and parameters of models 304 and the current values of the disease probability parameters 308. The log likelihood of a symptom could be averaged over all of the uncertainty that the system has for the underlying disease probability. For example, if the system maintains Beta distributions, the log likelihood could be the average log likelihood of a symptom, integrated over all possible values of rates that are generated by a Beta distribution.

However, this averaging process may not be analytically tractable, requiring expensive numerical integration. Instead, the symptom likelihood gradient component 310 can compute the log likelihood of a symptom assuming that the disease probability distribution attains its mean value under all possible disease probability distributions parameterized by disease probability parameters 308. This is known as a mean-field approximation. For a noisy-OR model, this mean field approximation results in applying the mean value qᵢ of the disease probability or rate to the noisy-OR model, above, and then computing the gradient with respect to the corresponding zᵢ. That is, the log likelihood of a symptom observation with respect to a disease parameter zᵢ that represents a mean probability or rate is:

```
If symptom sⱼ is negative,
        d log P(sⱼ|D) / d zᵢ = − rⱼᵢ qᵢ (1−qᵢ) / (1− rⱼᵢ qᵢ)
If symptom sⱼ is positive,
    d log P(sⱼ|D) / d zᵢ = P(sⱼ=false|D) rⱼᵢ qᵢ (1−qᵢ) / (1−rⱼᵢ qᵢ)
```

The disease probability updater 312 accepts the gradient computed by likelihood gradient calculation and uses it to update the disease probability parameters 308. The simplest such updater uses stochastic gradient descent:

Δzᵢ=ηd log P(sⱼ|D)/dzᵢ

where η is a step size, typically in the range of about 0.001 to 0.1 and Δ zᵢ is the update to the disease probability parameter zᵢ. One will appreciate that smaller or larger step sizes can be used and can be dependent on various factors, such as the number of symptom observations or a desire to reduce the possibility of false positives. For example, if the number of symptom observations exceeds a very large number of symptom observations (e.g., 1 million), then a smaller step size can be utilized while still effectively identifying potential intermittent diseases. One will also appreciate that in simpler embodiments, negative observations are not used to update the disease parameter zᵢ.

In some embodiments, the probability estimates can be improved further. For example, estimates of zᵢ are less noisy when the gradient is itself smoothed by a filter. This is known as “momentum”, and additional storage locations are used within the disease probability updater 312:

yᵢ=(1−α)yᵢ+α*d log P(sⱼ|D)/dzᵢ

Δzᵢ=ηyᵢ

where α is a momentum parameter, typically 0.99.

Other parameter updates are also possible. For example, a standard optimization procedure can be used within disease probability updater 312 (such as L-BFGS or conjugate gradient). Such standard optimization procedures, however, can require that symptom likelihood gradient component 310 produce not only the gradient of the log likelihood, but the log likelihood itself. Thus, in these optimization procedures, the gradient produced by symptom likelihood gradient component 310 can be summed across all observed symptoms before a step is taken.

Disease prior gradient component 314 is an optional component that is useful when the number of symptom observations is not large. Disease prior gradient component 314 keeps the disease probability parameters 308 from straying too far away from their a priori values when there is not enough evidence for such extreme values. A typical function that is computed by the disease prior gradient component is the Kullback-Leibler divergence between the current disease probability and the prior disease probability. The disease prior gradient component computes the gradient of such a function with respect to the disease probability parameters 308. The disease probability updater 312 can then alternate between using a symptom likelihood gradient and a disease prior gradient for use in updating the disease probability parameters 308. In either even, the disease probability updater 312 should operate to maximize the likelihood of an observed symptom, and minimize the Kullback-Leibler divergence between the current disease probability and the prior disease probability. It can be appreciated by one skilled in the art that the combination of the symptom likelihood gradient component 310 and the disease prior gradient component 314 serves to minimize the so-called “variational” cost function for performing inference. Hence, the overall operation of root cause determination component 204 is referred to as “variational gradient descent”.

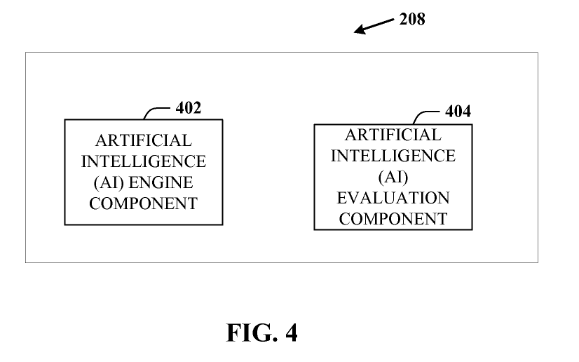

Referring to FIG. 4, the prioritization component 208 according to one embodiment is illustrated. Some of the functionality of the prioritization component 208 can be implemented using artificial intelligence. Specifically, artificial intelligence engine and evaluation components 402, 404 can optionally be provided to implement aspects of the subject invention based upon artificial intelligence processes (e.g., confidence, inference). For example, the prioritization component 208 can use artificial intelligence to determine the priority in notifying a user (e.g., network technician, doctor) of a current disease or root cause. The use of expert systems, support vector machines, greedy search algorithms, rule-based systems, Bayesian models (e.g., Bayesian networks), neural networks, other non-linear training techniques, data fusion, utility-based analytical systems, systems employing Bayesian models, etc. are contemplated by the AI engine 402. These training techniques can be calibrated using known data when the system being diagnosed is substantially working normally or to train the system for known disease/symptom pairings. For example, a model can be trained as to the number of customer affected due to a particular remote router failure/fault so that an appropriate priority level can be assigned when an incident occurs with that router.

In various embodiments, other implementations of AI as part of the root determination system can include aspects whereby, based upon a predicted root cause, the system can perform various actions to treat the root cause. For example, the system can alert a third-party network administrator of a failing router, reboot a misbehaving internal router, or switch to a backup server or server farm (if one is available). In addition, as previously mentioned, an optional AI component can infer the presence of a symptom when a particular symptom is impractical to measure directly.

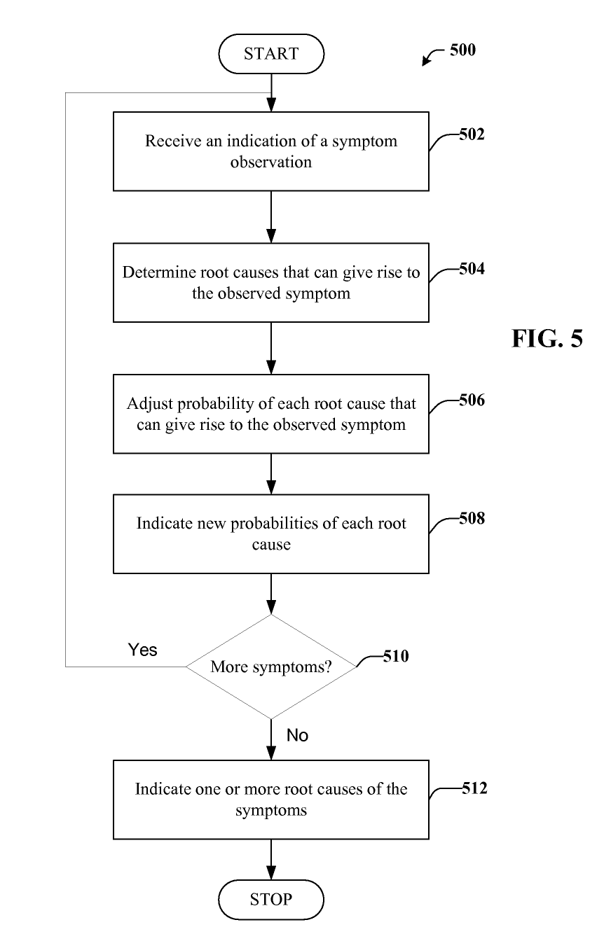

FIG. 5 illustrates a methodology in accordance with one embodiment. While, for purposes of simplicity of explanation, the methodology is shown and described as a series of acts, it is to be understood and appreciated that the claimed subject matter is not limited by the order of acts, as some acts can occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodology disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 5, an exemplary methodology 500 is depicted using variational gradient descent for historical analysis of symptoms. At 502, an indication is received of a symptom observation, such as from a log of symptom observations. At 504, root causes that can give rise to the observed symptom are determined. At 506, the probability of each root cause that can give rise to the symptom is adjusted, such as to decrease the overall cost function (e.g. increase similarity between the estimated root cause and the unknown true root cause). At 508, the new probabilities of each root cause are indicated. These probabilities can then be processed further by the alert component 206 or the prioritization component 210 and/or indicated directly to a local or remote user. At 510, it is determined if there are more symptom observations. If so, the methodology returns to 502 to process the next symptom observation and if not, it continues to 512. If the methodology is performed in substantially real-time, a time limit (e.g., 5 minutes) can be used as a maximum amount of time to wait for another symptom observation. At 512, the one or more root causes that were determined are indicated. These indications can be to another process or thread for secondary processing (e.g., written to a log, or processing by the prioritization component 208 of FIG. 2, processing by the alert component 206) or to a local or remote user.

One skilled in the art will appreciate a similar methodology can be used for substantially real-time or near real-time analysis using variational gradient descent. However, the currently detected root causes are indicated (e.g., periodically) while still analyzing additional symptoms, such as part of 508. The indications are useful for indicating time-varying root causes that are currently occurring.

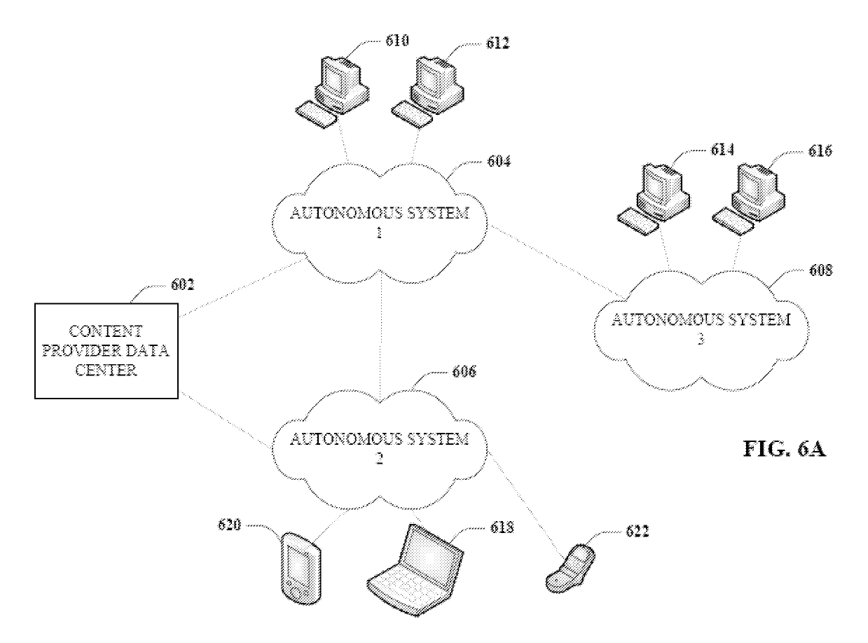

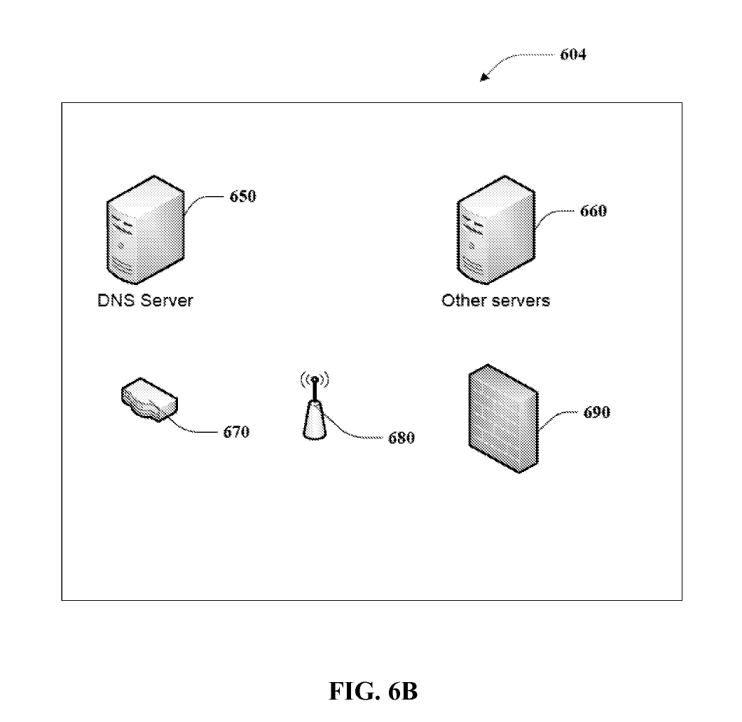

Referring to FIGS. 6A-6B, an exemplary, non-limiting scenario for using the root cause determination is illustrated. In particular, root cause determination is utilized to diagnose problems with distant connectivity problems to a content provider's data center 602. Although this exemplary networking scenario involves a wide area network, one will appreciate that root cause determination can be performed on a large internal network, such as one maintained within a large data center.

A wide-area network, such as the Internet, is used to connect remote client devices (610, 612, 614, 616, 618, 620, and 622 to the content provider's data center 602 via one or more autonomous systems (e.g., a third-party network provider such as an ISP) (604, 606, 608). Each autonomous system can include wired and/or wireless communication through which connections occur. The remote client devices can take different forms including personal computers, laptops (618), tablets, smart phones, PDAs (620), cell phones (622), game consoles, and digital video recorders. Each remote client device can run one or more clients, whether in software or hardware, to interact with the content provider's computing systems (not shown). The client is a potential fault source, such as when the client has a bug, in addition to any faults involving one or more autonomous systems.

The content provider's data center 604 can comprise one or more web servers, which log HTTP requests from clients. However, one will appreciate other types of servers, such as mail servers, audio/visual streams, SIP proxies, FTP file servers, can be used instead or in addition to web servers. The logs are used to detect and or infer symptom observations. For example, although the failure to connect may not be measured directly, a symptom observation can be inferred if there is a precipitous drop in the number of estimated connections from or via a particular autonomous system.

FIG. 6B illustrates an exemplary autonomous system with various components subject to intermittent or permanent failures. In the illustrated example, the autonomous system 604 comprises one or more DNS servers 650, one or more other servers 660, one or more pieces of network equipment 670, and optionally one or more wireless stations 680 and one or more firewalls/content filters 690. If any of these components fails or has intermittent problems, access to the content provider data center can be unacceptable for one or more customers, such as when access fails, packet loss is high, or a connection takes an unacceptably long time. Hardware, firmware, and/or software problems can be source of system faults. Other servers 660 can include DHCP servers, authentication servers, proxy servers (e.g. servers enforcing ISP bandwidth caps, caching servers, etc.). Networking equipment can include routers, switches, repeaters, bridges, access points, and hubs. One will appreciate that other components (not shown) of an autonomous system can also be sources of failures, such as internal wired media (e.g. when a cable is cut, shorted, or exposed to improper environmental conditions) or electrical equipment failures. One will also appreciate that a failure, even of the same component type, will affect a different number of customers. For example, if a cable gets cut in a rural area, a few customers of the content provider may be affected. However, if a cable gets cut in a major city, a very large number of customers may be affected.

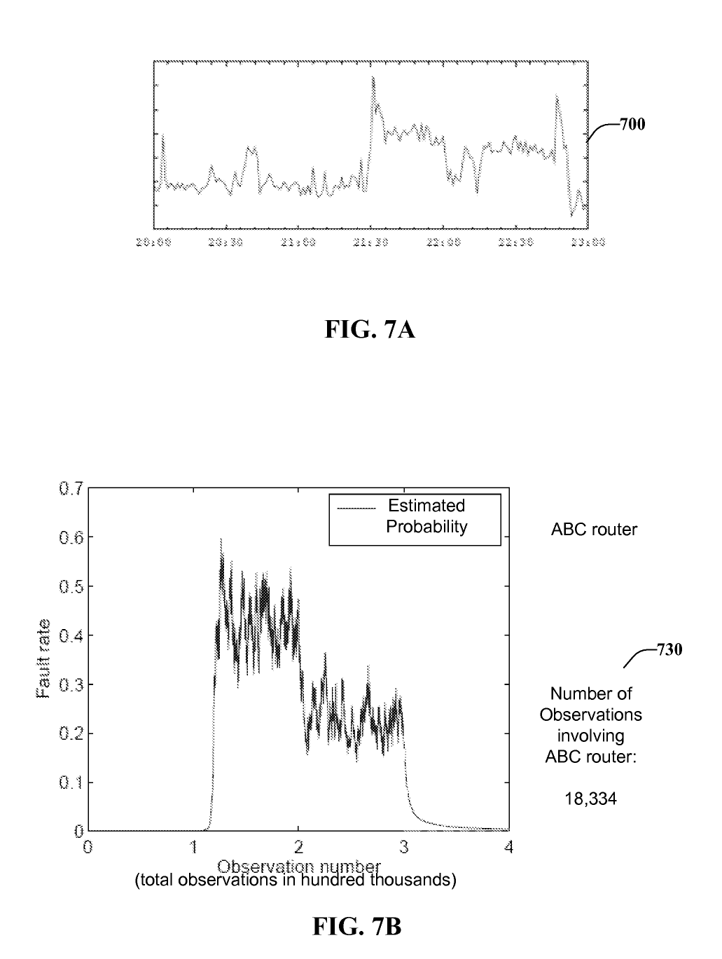

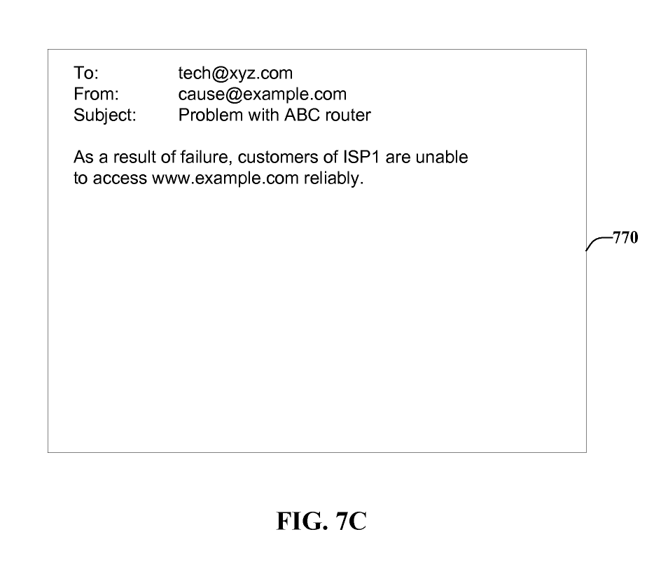

Referring to FIGS. 7A-7C, example indications of the root cause determination for the exemplary scenario are illustrated. In particular, FIG. 7A illustrates a timeline 700 of an observed event during a 3-hour time period. The graph begins with a low rate of background failures occurring due to broken browsers and problems at small Autonomous Systems. At 21:30, an incident occurs, and the failure rate increases for approximately 85 minutes.

FIG. 7B illustrates a user interface 730 containing a graph of a fault rate over a large number of observations. Although 400,000 total symptom observations were observed, only some of those symptom observations are related to the displayed ABC router and thus the number of symptoms associated with that router is also indicated to a user. In other embodiments, multiple graphs of key routers can be presented simultaneously.

FIG. 7C illustrates an email 770 sent to a network technician as result of the problems with ABC router. More or less information can be presented in other embodiments, such as the time since the root cause began, the probability of ABC router being a root cause of problem or the number of customers affected. In some embodiments, this information is left off as the alert component 206 and/or prioritization component 208 can curtail indications unless certain thresholds as to probability or number of customers affected exceeds various thresholds.

One skilled in the art will appreciate that the indications can be made in other manners in addition to or instead of the indications depicted in FIGS. 7A-7C, such as by phone call (e.g., using text to speech), instant messaging, blinking elements, or text/video messaging. One will also appreciate that the information presented can be edited and formatted for a particular presentation device type (e.g., cell phone vs. desktop computer).

One skilled in the art will appreciate that the scenario depicted in FIGS. 6A-6B and 7A-7C for root cause determination is exemplary. Patient diagnosis or the diagnosis of computing systems are additional, non-limiting alternative scenarios. For example, computing systems have numerous components, whether hardware or software, that can intermittently or permanently fail. Often these problems manifest themselves in manners that can be hard to determine the root cause of the problem.

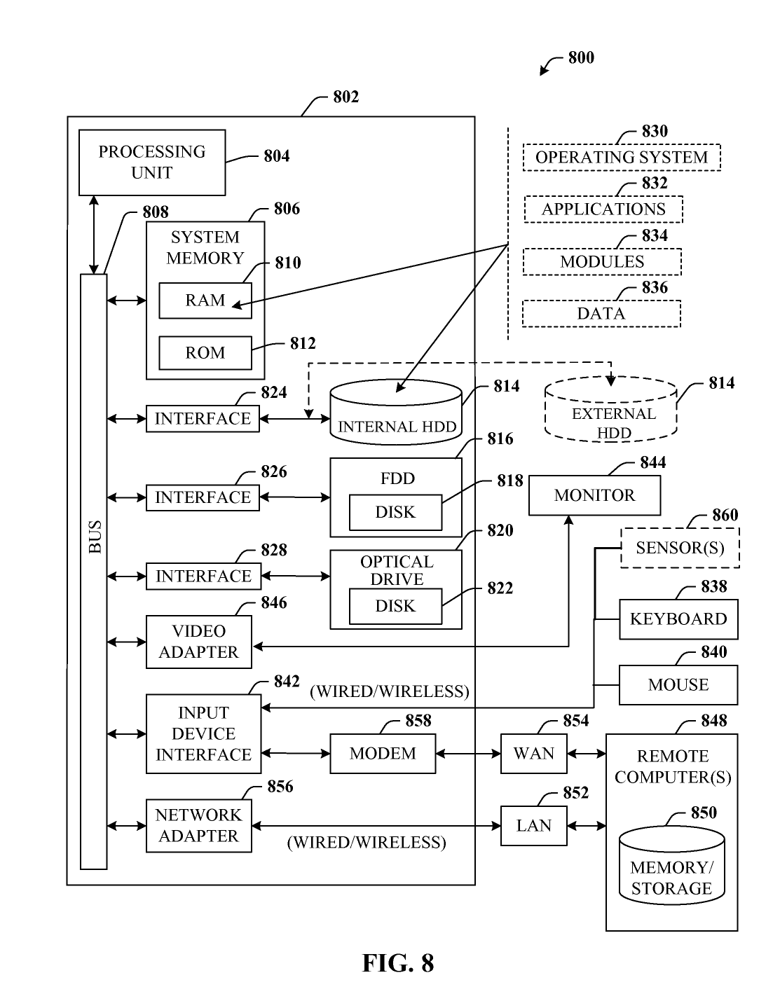

Referring now to FIG. 8, there is illustrated a block diagram of an exemplary computer system operable to execute one or more components of the disclosed media archiver. In order to provide additional context for various aspects of the subject invention, FIG. 8 and the following discussion are intended to provide a brief, general description of a suitable computing environment 800 in which the various aspects of the invention can be implemented. Additionally, while the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention can be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 8, the exemplary environment 800 for implementing various aspects of the invention includes a computer 802, the computer 802 including a processing unit 804, a system memory 806 and a system bus 808. The system bus 808 couples to system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, erasable programmable read-only memory (EPROM), electrically erasable programmable read-only memory (EEPROM), which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 can also be configured for external use in a suitable chassis (not shown), a magnetic floppy disk drive (FDD) 816, (e.g., to read from or write to a removable diskette 818) and an optical disk drive 820, (e.g. reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE1384 interface technologies. Other external drive connection technologies are within contemplation of the subject invention.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a remote computers, such as a remote computer(s) 848. The remote computer(s) 848 can be a workstation, a server computer, a router, a personal computer, portable computer, microprocessor-based entertainment appliance, a peer device or other common network node, various media gateways and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g. the Internet.

Various external input devices can be connected via the input device interface 842. The input devices depicted include wired/wireless connectivity to a keyboard 838, a mouse 840, and one or more sensors 860. The sensors can detect or observe some of the symptoms. However, more or less input devices can be utilized in other embodiments.

When used in a LAN networking environment, the computer 802 is connected to the local network 852 through a wired and/or wireless communication network interface or adapter 856. The adapter 856 can facilitate wired or wireless communication to the LAN 852, which can also include a wireless access point disposed thereon for communicating with the wireless adapter 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular, the determining of root causes and/or diseases is not limited to computer networks. Diseases affecting an operating system or a distributed computing system can also be diagnosed using similar methodology. Machines, such as vehicles and copiers, can also be diagnosed, even if some or all symptoms are manually entered. Medical diseases, whether afflicting a human, plant or animal, can also be diagnosed using the methodology.

As used in this application, the terms “component,” “module,” “system”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN).

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, in particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A method for determining root causes, comprising:
for each of multiple symptom observations,
receiving an indication of a symptom observation; and
adjusting a probability of each root cause that can give rise to the observed symptom; and
indicating one or more root causes of the observed symptoms.

2. The method of claim 1 wherein the indicating of one or more root causes of the symptoms includes:
for each of at least some symptom observations,
indicating a current probability of each root cause that can give rise to the observed symptom.

3. The method of claim 1 wherein for at least one symptom the receiving of the indication of a symptom observation includes receiving an indication of a substantially real-time symptom observation.

4. The method of claim 1 wherein the number of multiple symptom observations exceeds five thousand.

5. The method of claim 1 wherein the symptoms are medical symptoms.

6. The method of claim 1 wherein the symptoms are network observations and the root causes are a plurality of software or hardware faults.

7. The method of claim 1 wherein the indicating of one or more root causes of the observed symptoms includes indicating two or more root causes of the observed symptoms.

8. The method of claim 1 wherein the indicating of one or more root causes of the observed symptoms includes selectively indicating to a user one or more root causes based on predetermined rules.

9. The method of claim 1 wherein the adjusting of a probability of each root cause that can give rise to the observed symptom increases similarity between an estimated root cause and a true root cause of the observed symptom.

10. A root cause determination system comprising:
a symptom acquiring component that receives indications of multiple symptom observations; and
a root cause determination component that determines one or more root causes from the symptoms using variational gradient descent.

11. The system of claim 10 wherein the symptom acquiring component receives substantially real-time indications of symptom observations and the root cause determination component determines a current root cause in substantially real-time.

12. The system of claim 10 wherein the one or more root causes are at least one of medical diseases, faults of a computer system, and faults of a computer network.

13. The system of claim 10, further comprising an alert component that indicates at least one of the determined one or more root causes to a technician user.

14. The system of claim 10, further comprising a prioritization component that determines how to indicate at least one of the determined one or more root causes to a technician user.

15. The system of claim 14 wherein the prioritization component comprises an artificial intelligence component.

16. The system of claim 10 wherein the root cause determination component performs gradient descent in order to accomplish variational inference.

17. The system of claim 10 wherein the root cause determination component performs variational gradient descent without a calibration set.

18. A diagnostic tool comprising:
means for receiving an indication of multiple symptom observations; and
means for determining one or more diseases underlying the symptoms using variational gradient descent.

19. The diagnostic tool of claim 18 wherein the multiple symptoms exceed five thousand positive symptoms.

20. The diagnostic tool of claim 18 wherein the means for determining one or more diseases underlying the symptoms using variational gradient descent determines a substantially real-time estimate of disease probabilities.
